(19) United States
(12) Patent Application Publication
(10) Pub. No.: US 2012/0059884 A1
(43) Pub. Date: Mar. 8, 2012

(54) DEVICES, SYSTEMS, AND METHODS OF ACCESSING AND SHARING DIGITAL MEDIA CONTENT AMONG USERS WITH A WEB BASED SERVER

(75) Inventor: Leigh M. Rothschild, Sunny Isles Beach, FL (US)

(73) Assignee: MATTHEW INVENTIONS LLC, Sunny Isles Beach, FL (US)

(21) Appl. No.: 12/949,227

(22) Filed: Nov. 18, 2010

Related U.S. Application Data
(60) Provisional application No. 61/380,546, filed on Sep. 7, 2010.

(51) Int. Cl. G06F 15/16

(52) U.S. Cl. 709/206; 709/217

(57) ABSTRACT

Systems, devices, and methods for sharing digital media content between a plurality of users across a communication network are disclosed. A web server generates and hosts a web page with a unique web address by the web server, the web page embedded with the digital content and a digital content player. The web server provides the web page to one or more client devices. The client devices may coordinate with each other and the web server to substantially synchronizing play of the digital media content among the client devices from a designated time instant.

### CROSS-REFERENCE TO RELATED APPLICATIONS

The present application claims priority under the laws and rules of the United States, including 35 USC §120, to U.S. Provisional Patent Application No. 61/380,546 filed on Sep. 7, 2010. The contents of U.S. Provisional Patent Application No. 61/380,546 are herein incorporated by reference.

### BACKGROUND

The Internet and current networking technology has provided a platform for content providers to distribute different types of media to an array of different media consumers. For example, recording artists and recording companies have taken advantage of the Internet and networking technology to distribute their music to potential customers in a cost-effective manner. Further, individuals that provide written media through blogs and other sites can use the Internet and networking technology to reach readers in different geographic locations. In addition, the Internet provides video content providers a platform to distribute their content to a number of potential viewers. Content distribution typically occurs by an individual consumer requesting digital media (DM) content from the content provider and subsequently the DM content is downloaded, streamed, or otherwise provided to the individual consumer from a remote DM content server that may be owned and operated by a content provider.

### SUMMARY

Aspects of the present disclosure allow a content consumer to share DM content with one or more other content consumers in a multiple access session each consumer using a client device (e.g. computing device than can display or otherwise provide DM content). That is, one or more content consumers access the digital media content and can view the DM content at substantially the same time with each content consumer residing in different geographic locations. Each content consumer may also be called a user of the client device. In addition, the one or more users may communicate with each other during the multiple access session using a variety of communication methods (e.g. email, instant messaging, and mobile texting, Voice over IP, Video over IP, Chat, and Video Chat etc.). The Chat communication method may use proprietary Chat communication methods such as, or provided by, AOL, AIM, MSN, Yahoo, Gtalk, ICQ, Facebook, and MySpace. The one or more users may access the DM content using a client device such as a personal computer, smartphone, laptop computer, notebook computer, tablet computer or any other media device that allows a user to view, listen, or otherwise consume DM content. In addition, aspects of the present disclosure may allow a subset of the one or more users to control the DM content that includes controlling the play of the DM content from a designated point in time.

Moreover, the DM content may include both audio and video content and may be stored on one or more remote servers geographically dispersed across the Internet or some other communication network. Traditionally, the DM content may be accessed and controlled by one or more users, each with computing device having display device. Although each of the users accessing the same digital content may be residing in different locations, the users are not purposefully and in a controlled manner accessing and sharing the digital content at substantially the same time and in a substantially synchronized manner. Aspects of the present disclosure allows a user (or a set of users) to identify digital media content of interest to another set of users and invite the set of users to share and substantially view or listen to DM content at the same time as well as allow the set of users to communication with each other while viewing/listening to the digital media content. Further, aspects of the present disclosure describe the manner in which selected members of the set of users may further control aspects of the viewing/listening of the digital media content.

Within the embodiments described below, an exemplary system is disclosed that may include a web server coupled to the communication network using one or more server communication interfaces, the web server having one or more server processors coupled to one or more server storage devices, the one or more server processors executing one or more server software applications. Such a system may further include one or more client devices communicatively coupled to the web server across the communication network using one or more client communication interfaces, each of the one or more client devices having client processors coupled to one or more client storage devices, the one or more client processors executing one or more client software applications. Further, a first control client device and a set of invited client devices are a subset of the one or more client devices. In addition, the system may include a remote digital media content server coupled to the communication network using one or more server communication interfaces, the remote digital media content server having one or more content server processors coupled to one or more content server storage devices, the one or more content server processors executing one or more content server software applications wherein the digital media content is stored at the remote digital content server in one of the one or more content server storage devices. The first client device: (i) provides control instructions using one or more client software applications to the web server across the communication network, the control instructions identifying digital media content located in the remote digital media content server and requesting the web server to provide access to the digital media content; (ii) receives the digital media content embedded as a web page, the web page having a unique web address; (iii) sends a notification using a communication method to each client device in the set of invited client devices, the notification including a hyperlink to the unique web address; (iv) receives synchronization instructions to substantially synchronize play the DM content among the each client device in the set of invited client devices. Further, each client device in the set of invited client devices (i) receives the notification having the hyperlink to the unique web address from the first control client device; (ii) selects the hyperlink causing invitation instructions to be sent to the web server, the invitation instructions requesting the web server to provide access to, and substantially synchronous play of the digital media content among the first control client device and each client device in the set of invited client devices; (iii) receives synchronization instructions to substantially synchronize play the DM content among the each client device in the set of invited client devices and the first control client device. In addition, the web server (i) receives and processes the control instructions from the first control client device, and receives and processes the invitation instructions for each client device in the set of invited client devices, across the communication network; (ii) accesses the digital media content from the remote digital media content server and stores the digital media content in the one or more server storage devices based on the control instructions; (iii) generates and hosts a web page with a unique web address, the web page embedded with the digital content and a digital content player; (iv) provides the web page to the first control client device and each client device in the set of invited client devices; (v) substantially synchronizes play of the digital media content on the first control client device and each client device in the set of invited client devices.

Further, the first control client device sends a designated time instant associated with the digital content to the web server and the web server receives the designated time instant and substantially synchronizes play of the digital media content from the designate time instant on the first control client device and each client device in the set of invited client devices. In addition, the web server provides to the first control client device and each client device in the set of invited client devices a list of digital media content viewers that includes a first digital content viewer corresponding to the first client device and a set of invited digital media content viewers corresponding to the set of invited client devices.

Moreover, the first control client device and each client device in the set of invited client devices receive a list of digital media content viewers and displays the list of digital media content viewers on the user interface displaying the digital media content. Also, the first control client device provides user control instructions that include instructions that designate a set of control client devices that provides additional control instructions to the web server, the web server modifies the access, streaming, and control of the digital media content to the first client device and each client device in the set of invited client devices and the set of control client devices based on the user control instructions using one or more server software applications wherein the set of control client devices is a subset of the one or more client devices.

In addition, a subset of the one or more client software applications are one or more client social networking software applications and a subset of the one or more server software applications are server social networking software applications wherein the one or more client software applications and the one or more server social networking software applications are associated with a social networking website. Further, the client devices may have a list of contacts associated with the social networking website and a database of contacts wherein the first control client device provides a notification based on the list of contacts associated with the social networking website and the database of contacts.

Moreover, the web server may also be the remote digital content server. Also, one or more content displaying client devices that are a subset of the one or more client devices that display the digital media content wherein each content displaying client device exchanges messages with other content displaying client devices using one or more messaging client software applications wherein the one or more messaging client software applications is a subset of the one or more client software applications. The one or more messaging software applications can be selected from the group consisting of Instant Messaging, Voice over IP, email, mobile texting, Twitter, Facebook, and Chat software applications.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

FIGS. 1A-1B are an exemplary network that facilitates accessing and sharing of digital media content among users of client devices with a web server and a remote digital media content server;

FIG. 2A-2C are exemplary networks that facilitates accessing and sharing of digital media content among users of client devices with a web server and a remote digital media content server;

FIG. 2D is an exemplary functional block diagram of a control functions associated with the devices, systems, and methods of the present disclosure;

FIG. 3 is an exemplary functional block diagram of a web server that provides access to digital media content to a set of client devices;

FIG. 4 is an exemplary functional block diagram of a remote digital media content server provides digital media content to a set of client devices;

FIG. 5 is an exemplary functional block diagram of a client device that accesses and shares digital media content;

FIG. 6 is an exemplary network that facilitates accessing and sharing of digital media content among users of client devices with a web server and a remote digital media content server;

FIGS. 7A-7F are flowcharts that show exemplary methods of accessing and sharing of digital media content among users of client devices with a web server and a remote digital media content server.

### DETAILED DESCRIPTION

In the following detailed description, reference is made to the accompanying drawings, which for a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the following description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

Aspects of the present disclosure allow a content consumer to share DM content with one or more other content consumers in a multiple access session each consumer using a client device (e.g. computing device than can display or otherwise provide DM content). That is, one or more content consumers access the digital media content and can view the DM content at substantially the same time with each content consumer residing in different geographic locations. Each content consumer may also be called a user of the client device. In addition, the one or more users may communicate with each other during the multiple access session using a variety of communication methods (e.g. email, instant messaging, and mobile texting, Voice over IP, Video over IP, Chat, and Video Chat etc.). The Chat communication method may use proprietary Chat communication methods such as, or provided by, AOL, AIM, MSN, Yahoo, Gtalk, ICQ, Facebook, and MySpace. The one or more users may access the DM content using a client device such as a personal computer, smartphone, laptop computer, notebook computer, tablet computer or any other media device that allows a user to view, listen, or otherwise consume DM content. In addition, aspects of the present disclosure may allows a subset of the one or more users to control the DM content that includes controlling the play of the DM content from a designated point in time.

Moreover, the DM content may include both audio and video content and may be stored on one or more remote servers geographically dispersed across the Internet or some other communication network. Traditionally, the DM content may be accessed and controlled by one or more users, each with computing device having display. Although each of the users accessing the same digital content may be residing in different locations, the users are not purposefully and in a controlled manner accessing and sharing the digital content at substantially the same time and in a substantially synchronized manner. Aspects of the present disclosure allows a user (or a set of users) to identify digital media content of interest to another set of users and invite the set of users to share and substantially view or listen to DM content at the same time in a synchronized manner as well as allow the set of users to communication with each other while viewing/listening to the digital media content. Further, aspects of the present disclosure describe the manner in which selected members of the set of users may further control aspects of the viewing/listening of the digital media content.

DM content may be shared in different environments that may or may not depend on the type of DM content. For example, one type of DM content may be music content that may be shared among users across the Internet for entertainment purposes. Another example may be sharing an entertainment video on a video website such as YouTube among users across the Internet. A further example may be a training video to be viewed by employees of a company across different offices across the company's virtual private network. A user may invite other users to access the DM content and designate to play the DM content at a certain point in time within the digital media content and to substantially synchronize play of the DM content from the certain point among the users.

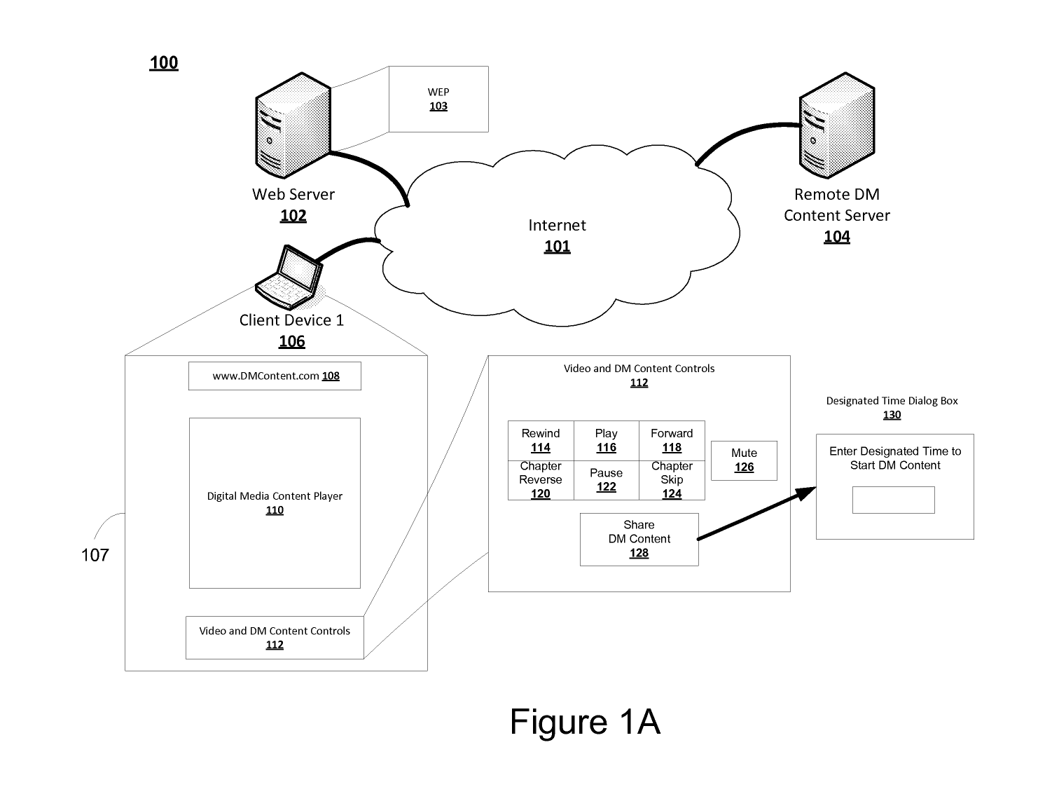

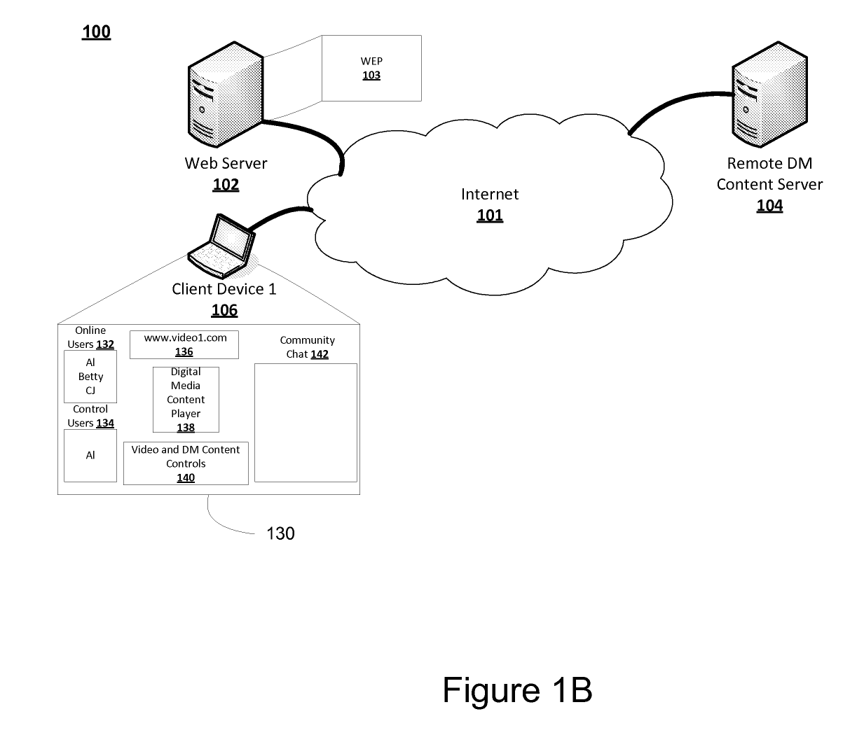

FIGS. 1A-1B show an exemplary network 100 that facilitates accessing and sharing of digital media content among users of client devices with a web server 102 and a remote digital media content server 104 across the Internet 101. Referring to FIG. 1A, an exemplary network 100 includes a web server 102 connected or coupled to a remote digital media (DM) content server 104, and client device 1 (106) across the Internet 101. Client device 1 (106) may be called a first control client device 106 and the user of client device 1 may be called a first control user. Further, the first control client device 106 may have a user interface 107 (e.g. web browser) that may display one or more visual components to a first control user. In addition, the first control user may access DM content from the remote DM content server 104 and view the DM content on the user interface 107 using a DM content player 110. The user interface may also list the web address (e.g. URL) 108 of the DM content. Typically, a DM content player 110 may be a plug-in software application on the user interface 107 of the first control client device 106. Further DM content player may provide video and DM content controls 112 to a first control user such as play 116, rewind 114, forward 118, pause 122, chapter reverse 120, chapter skip 124, and mute 126. Additionally, the first control user may want to share the DM content with another client device user and designate a particular time instant of the DM content for both the first control client device 106 and the other client device to synchronously view the DM content. The DM content player 110 may have a share DM content control button 128 associated with the video controls 112 to initiate sharing of the DM content to other client device users. When selected, the share DM content control button may cause a designate time instant dialog box 130 to open that allows the first control user to designate a time to start synchronously viewing the DM content.

Selecting the control button and inputting a designated time instant by the first control user provides play and control instructions that may include identification information of both the DM content and client device 1 (106) to a Web Based Exchange Program (WEP) 103 residing and implemented on the web server 102. The identification information in the play and control instructions may include the IP address of the remote DM content server 104, the name of the DM content, the IP address of the first control client device 106, and the user name associated with first control user. The WEP 103 may receive then process the play and control instructions from the first control client device 106. Subsequently, the WEP 103 may access the DM content stored in the remote DM content server 104 and store the DM content in the web server 102 based on the play and control instructions.

Referring to FIG. 1B, the WEP 103 may provide access, stream or otherwise provide the DM content to the first control client device 106 across the Internet 101. The first control client device 106 may provide the DM content received from the WEP 103 to the first control user in the form of a web page using the first control client device's web browser or some other type of user interface 130. Such a web page 130 is hosted by the web server 102 and is provided by the WEP 103. The DM content may be within a DM content player 138 embedded in the web page by methods known to those of ordinary skill in the art. The web page/user interface 130 may also list the URL or web address 136 of the web page hosted by the web server 102. In addition, the user interface 130 may display other functions provided by the WEP 103 to the first control client device 106 specific to the sharing the DM content to other users such as communication methods that includes instant messaging, emailing, Twitter, etc. to invite other users to view the DM content 142. The user interface 130 may list other client device users 132 that are currently connected to the Internet 101 or online and also list of users that may control sharing of the DM content 134.

The DM content player 138 may be able to play the received DM content but may pause the DM content at the point at when the first control user selected the control button to initiate the sharing of the DM content among users. The user interface 130 may include video and DM content control button that includes such functions as pause, mute, play, rewind, forward, chapter skip, chapter reverse or other video controls. Alternatively, the DM content may be paused at the designated time entered by the first control user when selecting the control button to share the DM content with other users.

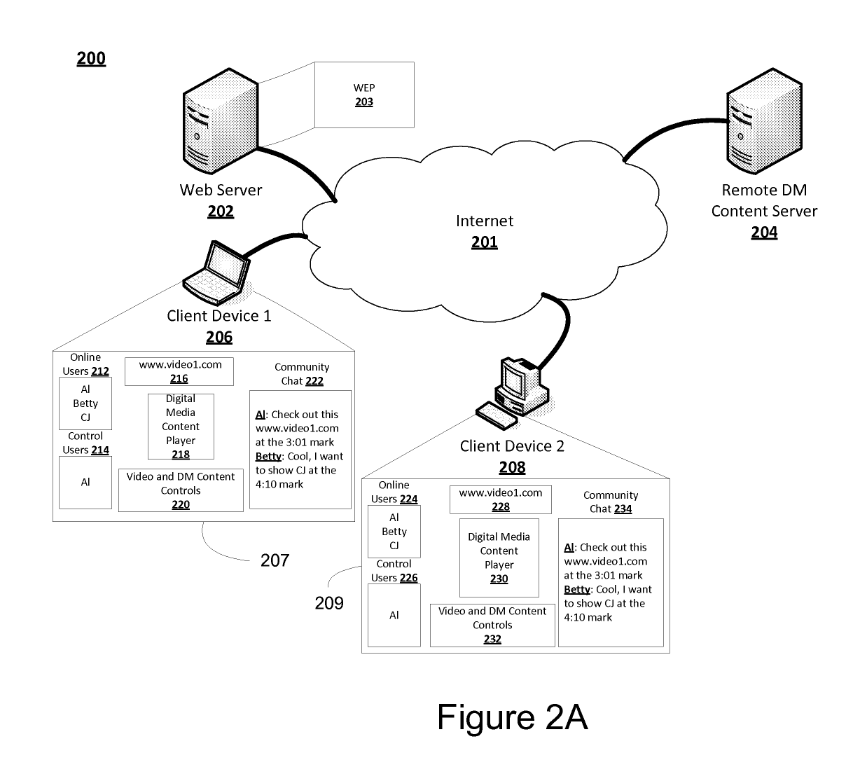

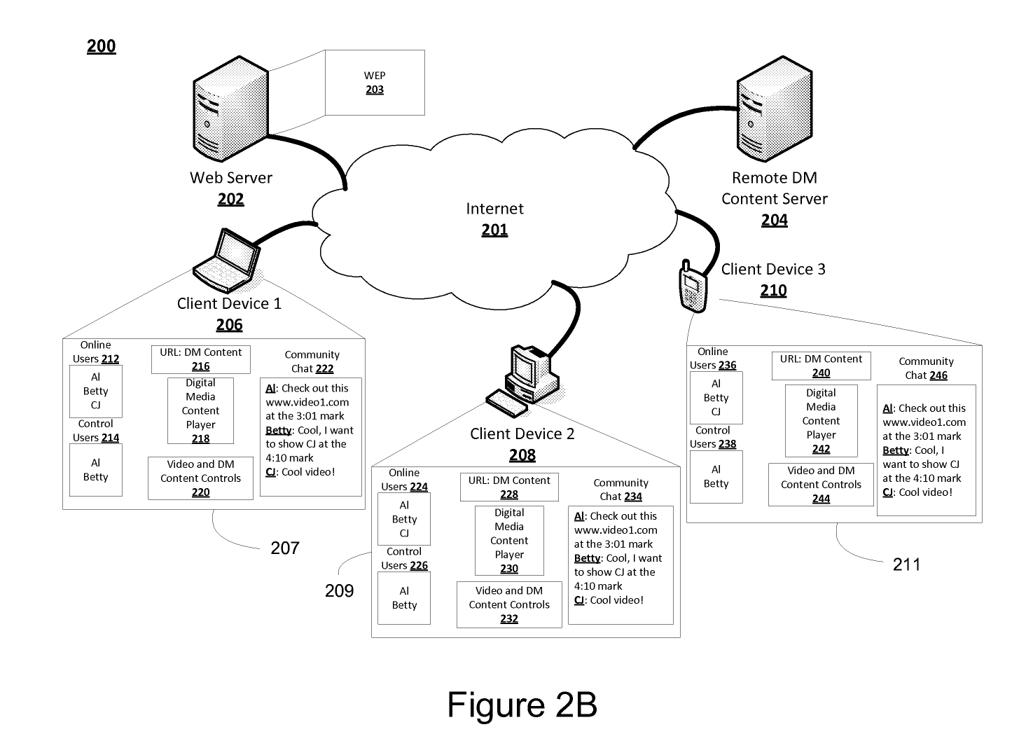

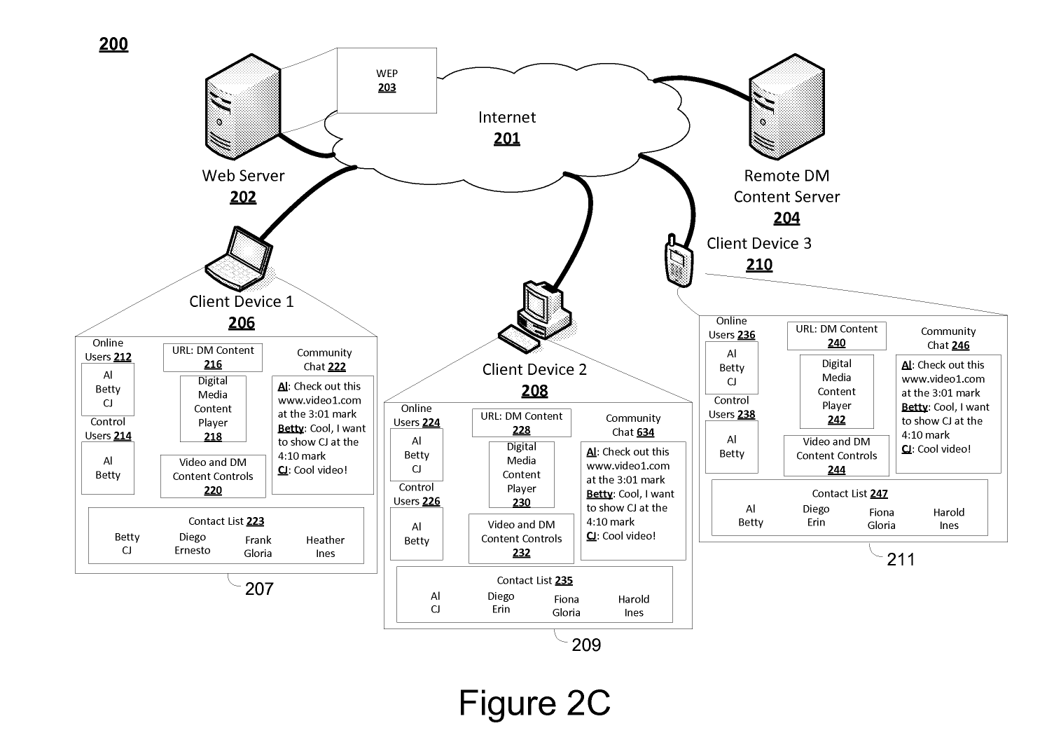

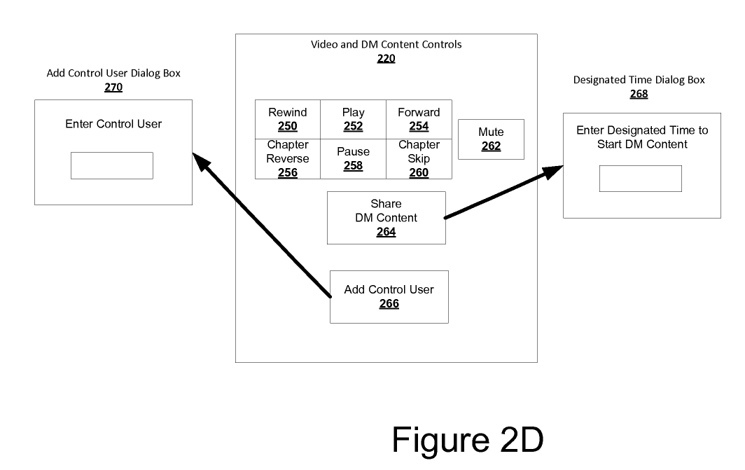

FIG. 2A-2C show an exemplary network 200 that facilitates accessing and sharing of digital media content among users of client devices with a web server 202 and a remote digital media content server 204. Referring to FIG. 2A, an exemplary network 200 includes a web server 202 connected or coupled to a remote digital media (DM) content server 204, and client device 1 (206) and a client device 2 (208) across the Internet 201. Client device 1 (206) may be a first control client device 206 and the user of client device 1 may be called a first control user. Further, client device 2 (208) may be a first invited client device 208 and the user of client device 2 may be called a first invited user. Further, the first control client device 206 may have a user interface 207 (e.g. web browser) that may display web page having one or more visual components to a first control user similar to user interface shown in FIG. 1B. The web page may be provided WEP 203 and hosted by the web server 202. The user interface 207 may include a DM content player 218 that may play DM content accessed from the remote DM content server and stored in the web server 202 by the WEP 203. The DM content player 218 may have Video and DM content controls 220 to operate the DM content player and to share the DM content with other users. Further, the user interface 207 may display the web address or URL 216 of the web page embedded with the DM content and hosted on the web server 202. In addition, the user interface 207 may list other client device users 212 that are currently connected to the Internet 201 or online and also list of users that may control sharing of the DM content 214. Also, the user interface may have a community chat function 222 as a method to communicate with one or more online users.

The first control user may want to share the DM content being displayed by the DM content player 218. Consequently, the first control user may notify the first invited user to view the DM content using the community chat communication function 222 or some other available communication method. The first control user may provide identification information of the DM content such as a hyperlink in the notification (www.video1.com) to the first invited user. Further, using the video and DM content controls (as discussed when describing FIG. 1A), may designate a particular time instant (e.g. 3:01 time mark) to have the first control user and the invited user to synchronously view the DM content. The first control client device 206 may send such information within a set of instructions to the web server 202 across the Internet 201. Further, the web server 202 may receive and process the set of instructions using the WEP 203. Consequently, the WEP 203 may modify access to the DM content based on the designated time instant provided in the received instructions. For example, if the DM content on the web page (e.g. www.video1.com) is paused at the start of the DM content, the WEP may forward the DM content and pause at the designated time instant (e.g. 3:01).

The first invited user may select the hyperlink in the received notification, thereby sending invitation instructions to the WEP 203 residing on the web server 202. In response to the selection of the hyperlink and receiving the invitation instructions, the WEP provides the DM content to the invited client device 208 in the form of a web page or user interface 209 containing a DM content player 230 with the DM content paused at a designate time point as well as video control and DM control functions 232. The user interface 209 may be similar to the user interface 207 of the first control client device 206 and may display one or more visual components to a first invited user. The visual components may include listing a URL or web address of the DM content 228. Further, the user interface 209 may list other client device users 224 that are currently connected to the Internet 201 or online as well as other user that may control the play of the DM content 226.

Moreover, the WEP may provide instructions to both the first control client device 206 and the first invited client device 208 to substantially synchronize viewing of the DM among the users. Specifically, the instructions from the WEP may be received and processed by one or more client software applications associated with the DM content player (218 and 230) of each client device (206 and 208). The client software applications in each client device (206 and 208) may then buffer the received DM content until a sufficient amount of the DM content is stored on each respective client device (206 and 208). Based on WEP instructions, the client software applications on each client device (206 and 208) may control the respective DM content player to substantially synchronize play of the video from the designated time instant provided by the first control user.

Referring to FIG. 2B, the user interface 209 of the invited client device 208 may also have a community chat function or similar instant messaging communication method 234 for the first invited user to communicate with the first control user. Further, the first invited user (208) may also want to share the DM content with a user of client device 3 (210) and substantially synchronize the viewing of the DM content among client device 1 (206), client device 2 (208), and client device 3 (210) at certain designated time point as shown in the community chat area (222 and 234) of the user interfaces (207 and 209). The first control user may use the video and DM content controls 220 to provide the first invited user of the first invited client device 208 to control the DM content. Referring to FIG. 2D, the video and DM controls 220 may be similar to the video and DM controls depicted in FIG. 1A. However, as shown in FIG. 2D, the video and DM controls 220 may include an add control user control button 266 that open a dialog box 270 allowing the first control user to enter the identification information (e.g. username) of the first invited user to be a control user for the DM content.

Referring to FIG. 2B, after entering the identification information of an additional control user, control instructions may be sent from the first control client device 206 to the WEP 203 on the web server 202. The WEP 203 may process the control instructions and allow the first invited user and first invited client device 208 to control or modify access to the DM content. Consequently, the first invited user may be called the second control user and the first invited client device 208 may be called the second control client device 208. The video and DM controls 232 on the second control device's user interface 209 may include DM controls for the second control user, similar to the video and DM content controls shown in FIG. 2D, to designate a time instant to initiate substantially synchronous viewing of the DM content. Further, the second control user may invite a user of client device 3 (210) to view the DM content by inviting him/her through the use of the community chat (222, 234, and 246) and providing the user of the client device 3 with a hyperlink to the web page embedded with the DM content. The user of client device 3 may be called the second invited user and client device 3 (210) may be called the second invited client device 210.

The second invited user may select the hyperlink in the community chat area 246 of the user interface 211, thereby sending invitation instructions to the WEP 203 residing on the web server 202. In response to the selection of the hyperlink and receiving the invitation instructions, the WEP provides the DM content to the second invited client device 210 in the form of a web page or user interface 211 containing a DM content player with the DM content paused at a designate time point, video control and DM control functions as well as other functions. The user interface 211 similar to the user interface 207 and 209 may display one or more visual components to the second invited user. Further, the user interface 211 may list a uniform resource locator (URL) or web address of the DM content 240. One or more client device software applications may further provide the second invited user with video and DM content controls 244 when viewing the DM content. In addition, the user interface 211 may list other client device users 236 that are currently connected to the Internet 201 or online. Further, the WEP 203 may provide user interfaces (207, 209, and 211) with an updated list of control users (214, 226, 238).

Referring to FIG. 2C, persons of ordinary skill in the art would recognize that the user interfaces (207, 209, and 211) may import contacts from other computer programs and social networking sites associated with a user of a client device. These computer programs and social networking sites may include Outlook, Outlook Express, Google Mail, Lotus Notes, AOL, My Space, Linked In, Facebook, Twitter among others. The client device user interfaces (207, 209, and 211) may display the contact list (223, 235, and 247) on their respective user interface. A control user may designate one or more contacts from the contact list displayed on the user interface as invited users to share DM content among them. The control user may send a notification that includes a hyperlink to the DM content using a control client device's communication methods (e.g. instant messaging) to client devices of the invited users. Further, the control user may send instructions to the WEP 203 on the web server 202 to share the DM content to the invited user gathered form the social networking contact list. The invited user may select the hyperlink to access the DM content from the WEP 203 and web server 202 as discussed in the present disclosure.

Note, persons of ordinary skill in the art may understand that the Internet 201 that is depicted in FIG. 2A-2C is exemplary, and that any communication network may used with the network devices pictured therein, including but not limited to Local Area Networks, Wide Area Networks, Wireless Networks, Cellular networks, WiFi Networks, and WiMax networks. Further, persons of ordinary skill in the art would understand that a client device may be any network device or computing device that includes a display or speaker to view or listen to digital media content that includes, but is not limited to, a personal computer, a laptop, a smartphone, a Personal Digital Assistant (PDA), a notebook, or a tablet personal computer.

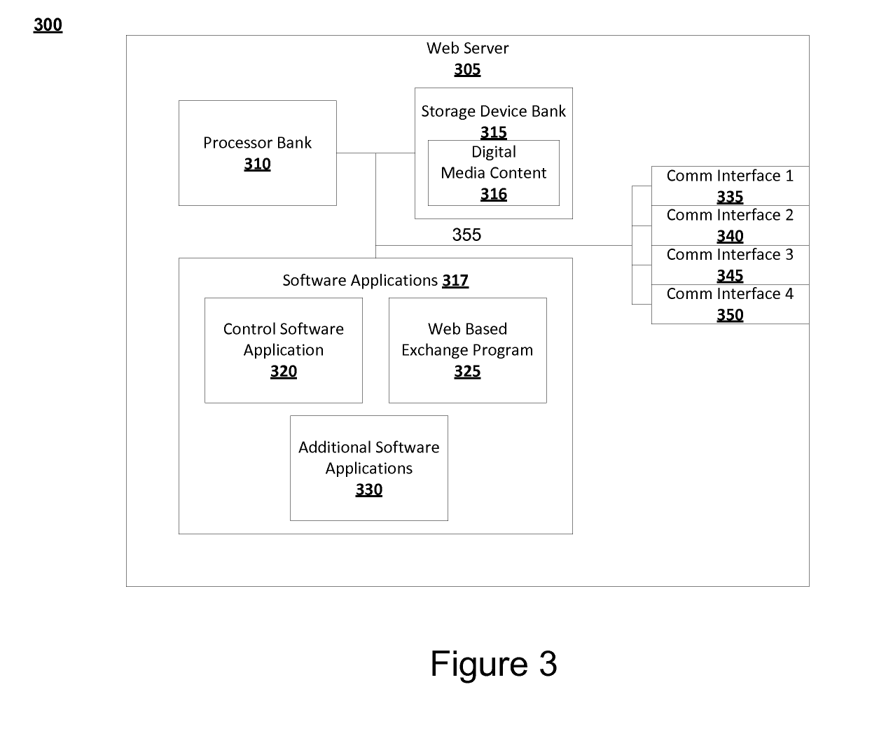

FIG. 3 is an exemplary functional block diagram 300 of a web server 305 that provides access to digital media content to a set of client devices. The web server 305 may include several different components such as a processor bank 310, storage device bank 315, one or more software applications 317, and one or more communication interfaces (335-350). The processor bank may include one or more processors that may be co-located with each other or may be located in different parts of the web server 305. The storage device bank 315 may include one or more storage devices. Types of storage devices may include memory devices, electronic memory, optical memory, and removable storage media. The one or more software applications 317 may include a control software application 320, Web Based Exchange Program (WEP) 325, and additional software applications 330. The control software application 320 may implement software functions that facilitate the functions of the web server 305.

The WEP 325 may receive instructions from a control client device to share DM content stored in a remote DM content server to one or more invited client devices. To such an extent, the WEP 325 may enable the web server 305 to access the DM content from a remote DM content server and store the DM content 316 in the storage device bank 315. Based on the received instructions, the WEP may provide the DM content and associated information (e.g. web address of DM content, list of control users, list of online users, etc.) to the one or more invited client devices to be displayed as embedded in a web page on the user interfaces of the respective invited client devices as described in the present disclosure.

Further, the control client device may specify a time instant within the DM content to start viewing/listening the DM content. In addition, the WEP 325 may facilitate the substantially synchronous viewing/listening of the DM content among the control client device and the one or more invited client devices. This may include sending information or instructions to client software applications to buffer a sufficient portion of the DM content and then play the video content at the substantially the same time instant among the control client device and the one or more invited client devices. Additional software application 330 may be other software applications that assist in performing other functions of the web server.

Each of the communication interfaces (335-350) shown in FIG. 3 may be software or hardware associated in communicating to other devices or to a web server user. The communication interfaces (335-350) may be of different types that include a user interface, USB, Ethernet, WiFi, WiMax, wireless, optical, cellular, or any other communication interfaces coupled to a communication network.

An intra-device communication link 355 between the processor bank 310, storage device bank 315, software applications 317, and communication interfaces (335-350) may be one of several types that include a bus or other communication mechanism.

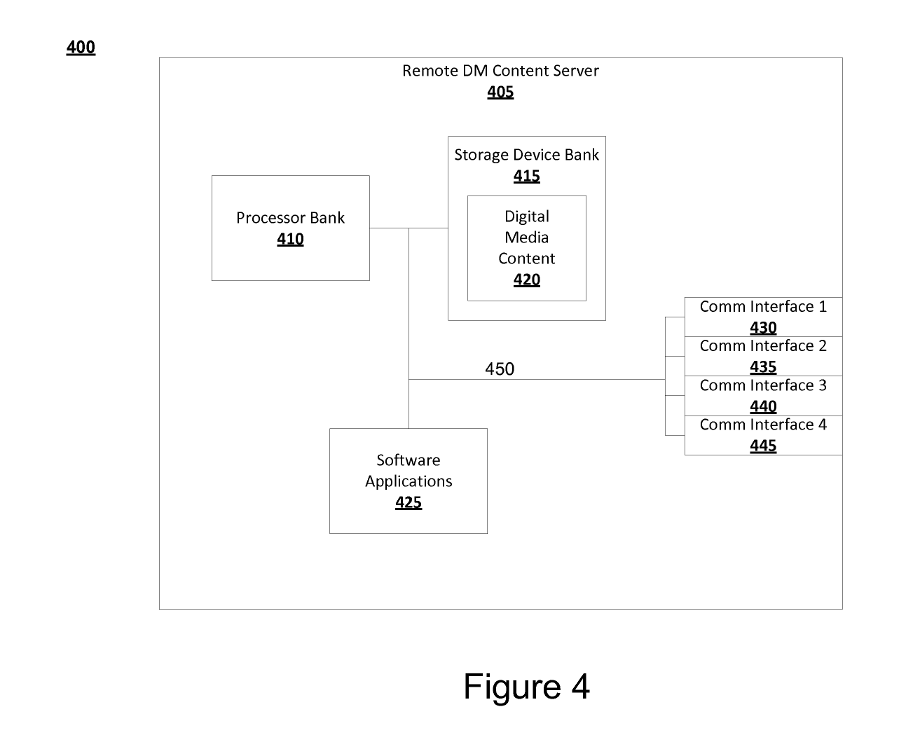

FIG. 4 is an exemplary functional block diagram 400 of a remote digital media (DM) content server 405 providing digital media content to a set of client devices. The remote DM content server 405 may include several different components such as a processor bank 410, storage device bank 415, one or more software applications 425, and one or more communication interfaces (430-445). The processor bank 410 may include one or more processors that may be co-located with each other or may be located in different parts of the remote DM content server 405. The storage device bank 415 may include one or more storage devices. Types of storage devices may include memory devices, electronic memory, optical memory, and removable storage media. The DM content 420 that may be provided to the set of client devices may be stored in one of the storage devices within the remote DM content server. The one or more software applications 425 may include control software applications and additional software applications 330. The control software applications may implement software functions that assist in performing certain tasks for the remote DM server such as providing access to the DM content, streaming the DM content to the set of client devices, or transmitting DM content to a web server.

Each of the communication interfaces (430-445) shown in FIG. 4 may be software or hardware associated in communicating to other devices or to a web server user. The communication interfaces (430-445) may be of different types that include a user interface, USB, Ethernet, WiFi, WiMax, wireless, optical, cellular, or any other communication interface coupled to communication network.

An intra-device communication link 450 between the processor bank 410, storage device bank 415, software applications 425, and communication interfaces (430-445) may be one of several types that include a bus or other communication mechanism.

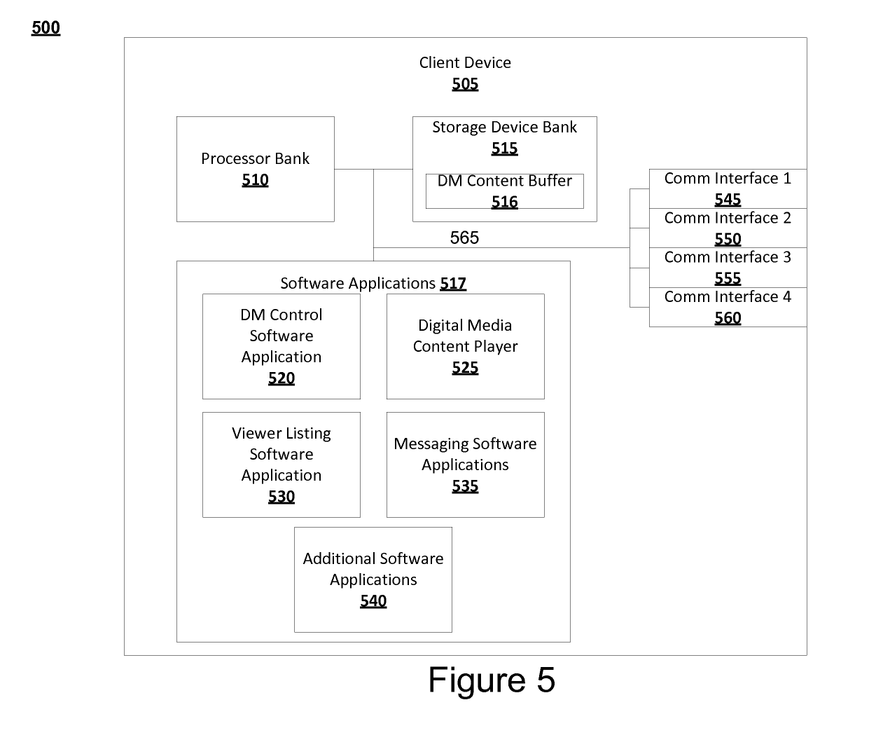

FIG. 5 is an exemplary functional block diagram 500 of a client device that accesses and shares digital media content. The client device 505 may include several different components such as a processor bank 510, storage device bank 515, one or more software applications 517, and one or more communication interfaces (545-560). The processor bank 510 may include one or more processors that may be co-located with each other or may be located in different parts of the client device 505. The storage device bank 515 may include one or more storage devices. Types of storage devices may include memory devices, electronic memory, optical memory, and removable storage media. The one or more software applications 517 may include a DM control software application 520, DM content player 525, viewer listing software 530, messaging software applications 535 and additional software applications 540. The DM control software application 520 may receive instructions from a WEP to not only display the DM content in the form of a web page and include control and other functions as discussed in the present disclosure but also may implement software functions that substantially synchronize the playing of DM content with other client devices. Further, the DM control software applications 520 may command the DM content player 525 to start displaying the DM content from a specified time instant based on the instructions provided by the WEP. In addition, the DM control software applications 520 may provide DM content controls such as play, stop, pause, mute forward, rewind, chapter skip, and chapter rewind. Also, the DM control software application 520 may instruct components of the client device to buffer or store a sufficient portion of the DM content to facilitate synchronous viewing of the DM content among the client device 505 and other client devices viewing the DM content. A DM content buffer 516 may be part of the storage device bank that would buffer or store a sufficient amount of DM content to provide substantially synchronous viewing of the DM content. The DM content player 525 is a client software application that plays the DM content from the specified time given in the instructions received from the WEP. The viewer listing software application 530 may list, by name, the users of the client devices that may synchronously view the DM content on a client device user interface and list the online users and control users of the DM content. Messaging software applications 535 allow users of the client device and other users of other client devices to communication while viewing the DM content. The messaging software applications 535 may include, but is not limited to, instant messaging, mobile texting, email, Facebook, and twitter. Also, there may be additional software applications 540 that may assist the client device in implementing the client device's various functions.

Each of the communication interfaces (545-560) shown in FIG. 5 may be software or hardware associated in communicating to other devices or to a web server user. The communication interfaces (545-560) may be of different types that include a user interface, USB, Ethernet, WiFi, WiMax, wireless, optical, cellular, or any other communication interface coupled to communication network.

An intra-device communication link 565 between the processor bank 510, storage device bank 515, software applications 517, and communication interfaces (545-560) may be one of several types that include a bus or other communication mechanism.

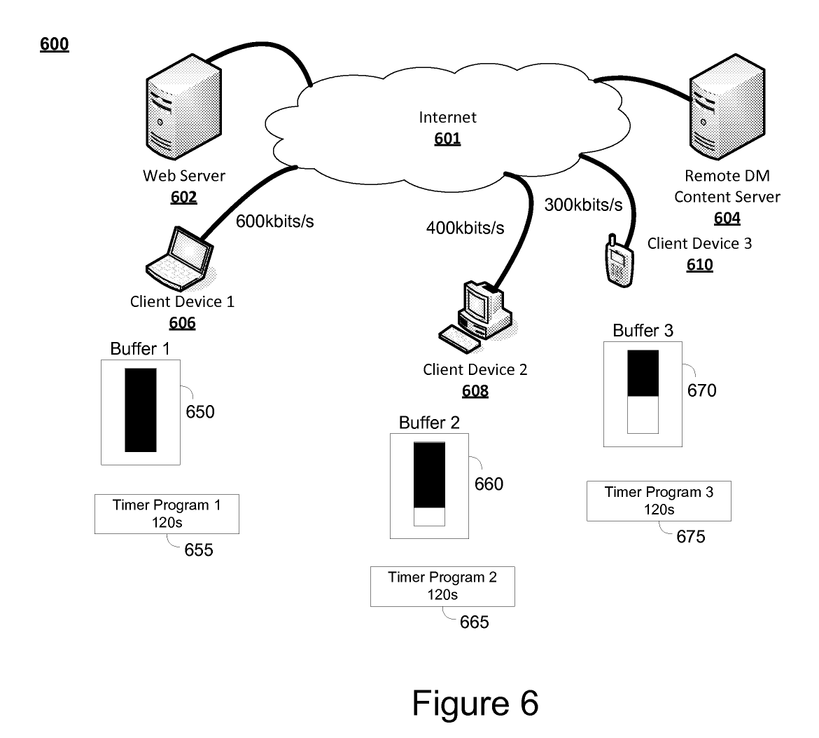

FIG. 6 is an exemplary network 600 that facilitates accessing and sharing of digital media content among users of client devices (606, 608, and 610) with a web server 602 and a remote digital media content server 604. Similar to the exemplary networks, components, devices in FIG. 2A-2C, the exemplary networks, components, and devices in FIG. 6 that facilitates accessing and sharing of digital media content among users of client devices (606, 608, and 610) with a web server 602 and a remote digital media content server 604.

Moreover, each client device may have a buffer to store the DM content and assist in the substantially synchronized playing of the DM content among the client devices. In response to, and after receiving instructions from a control client device, the web server 602 may access and store DM content from the remote DM content server 604 and then provide access, stream or otherwise provide the DM content to the client devices based on the instructions using a Web Based Exchange Program (WEP). Further the WEP may provide commands to client device software applications to gather network information from the client device which may in turn assist in substantially synchronizing the play of the DM content among the client devices.

For example, the WEP may query network information such as round trip time (RTT) from a client device to the web server 602. Alternatively, the WEP may use a PING command or other diagnostic tools to determine the RTT or other network information between the client device and the web server. Additionally, the client device may further provide the RTT or other network information to the WEP on the web server 602. The WEP may process the RTT or network information to determine an effective stream rate of DM content from the web server to the client device and provide instructions to the client device software applications directed to substantially synchronizing play of the DM content among the client devices based on such an effective stream rate.

For example, client device 1 (606) may have a round trip delay of 1 second between itself and the web server 602. Further, client devices 2 and 3 (608 and 610) may have RTT of 2 seconds and 4 seconds, respectively, to the web server 202. The RTT for each client device (606, 608, and 610) may correspond to client device 1, client device 3, and client device 3 receiving streaming video at 600 kbits/s, 400 kbits/s, and 300 kbits/s, respectively. In addition, the DM content player of each client device may play the DM content at a rate of 500 kbits/s. If the DM content is 60 MB in length then client device 1 takes 100 seconds to stream the entire DM content, client device 2 150 seconds to stream the entire DM content, and client device 3 200seconds to stream the entire DM content. Persons of ordinary skill in the art would recognize that a synchronous algorithm balances the buffering needed to synchronize play of the DM content among the client devices and the amount of time it may take to buffer the DM content. For example, one synchronous algorithm may be to buffer all the DM content in each client device and then synchronously playing the DM content to all users of the client devices. However, such an algorithm may be inefficient in both memory usage of each client device and waiting time for the user. A user for client device 1 may not desire to wait an additional time for client device 3 to buffer the DM content.

An alternative synchronizing algorithm may be, as persons of ordinary skill in the art would recognize, that the each client device may wait at least 120 seconds such that client device 3 has buffered enough of the DM content to allow for substantially synchronous play. In such an example, client device 1 buffers all 60 MB of DM content within the 120 second time period, client device 2 buffers 48 MB of the DM content, and client device 3 buffers 36 MB of DM content. After 120 second time period, the DM content media player on each client device may play the DM content at a rate of 500 kbits/s. Thus, for client device 3, the initial buffered 36 MB of DM content would be played by the DM content media player within 72 seconds. However, in 72 seconds of time an additional 21.6 MB of DM content would be buffered by client device 3. Further, the DM content player would take 43.2 seconds to play the additional 21.6 MB of DM content. In such a 43.2 second period, client device 3 would have buffered the remaining portion of the DM content.

A timer program associated with each client device may keep track and countdown the initial waiting period (e.g. 120 seconds in the present example) during the initial buffering stage. Thus, in the above example, the Timer Program for each client device (655, 665, and 675) would count down from 120 seconds, the waiting time period for each user until substantially synchronous play of the DM content may commence. Persons of ordinary skill in the art would understand that other synchronous algorithms may be incorporated into aspects of the embodiments to efficiently initiate substantially synchronous play of DM content among the users of the client devices.

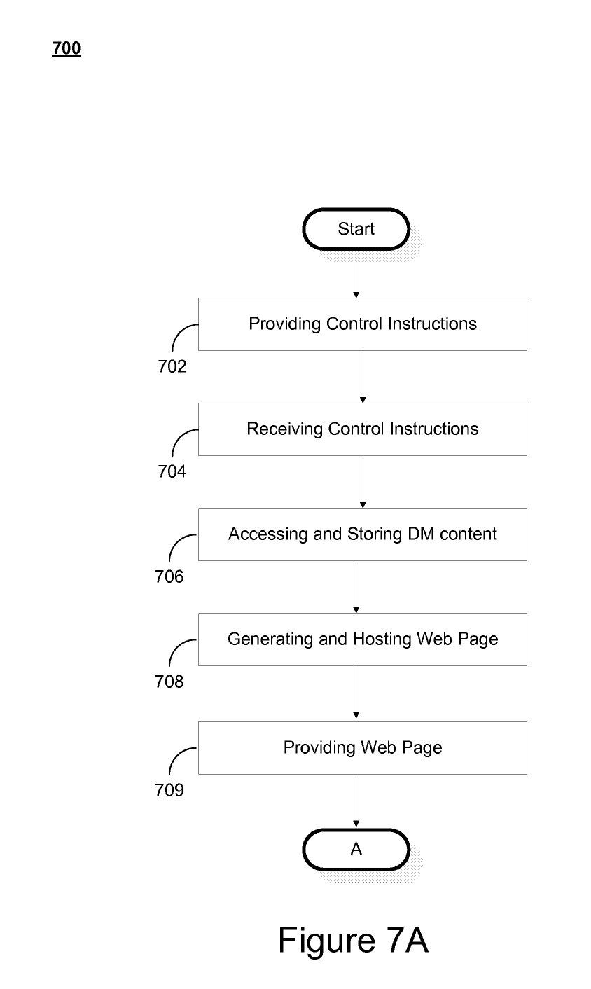

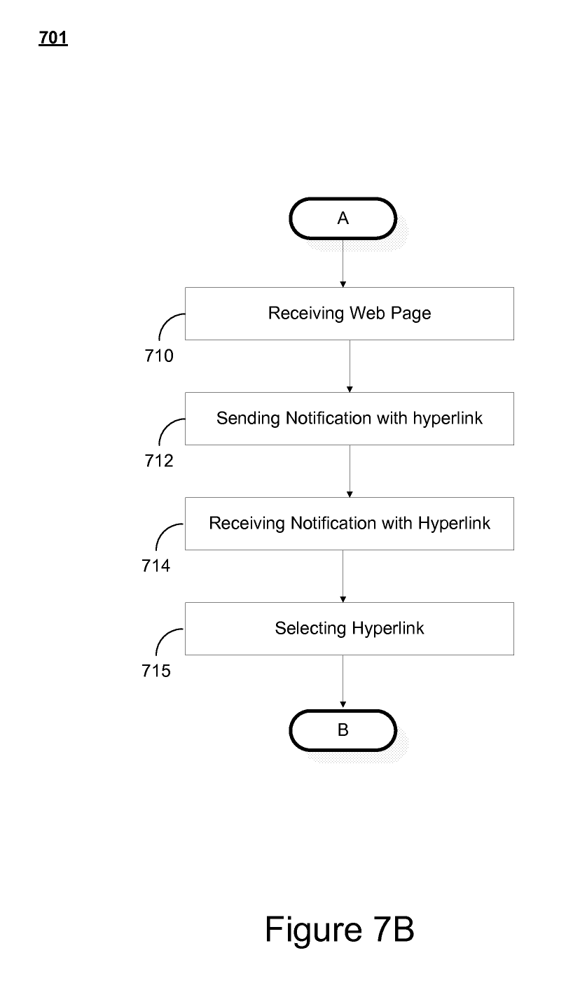

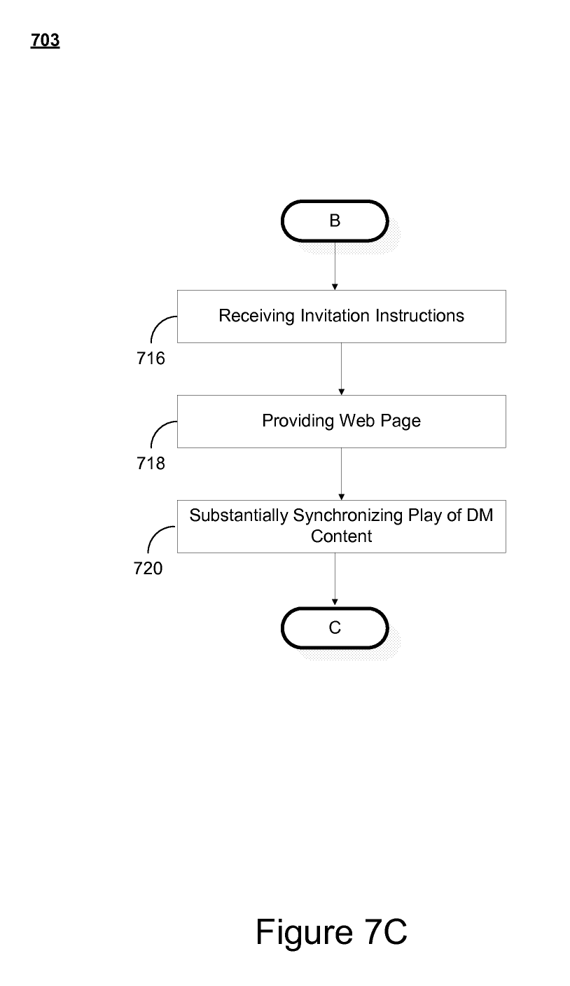

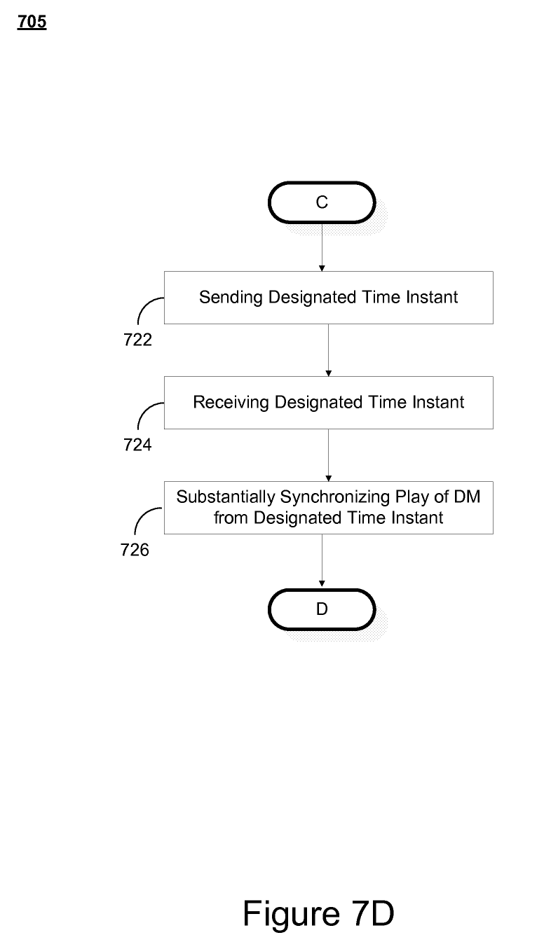

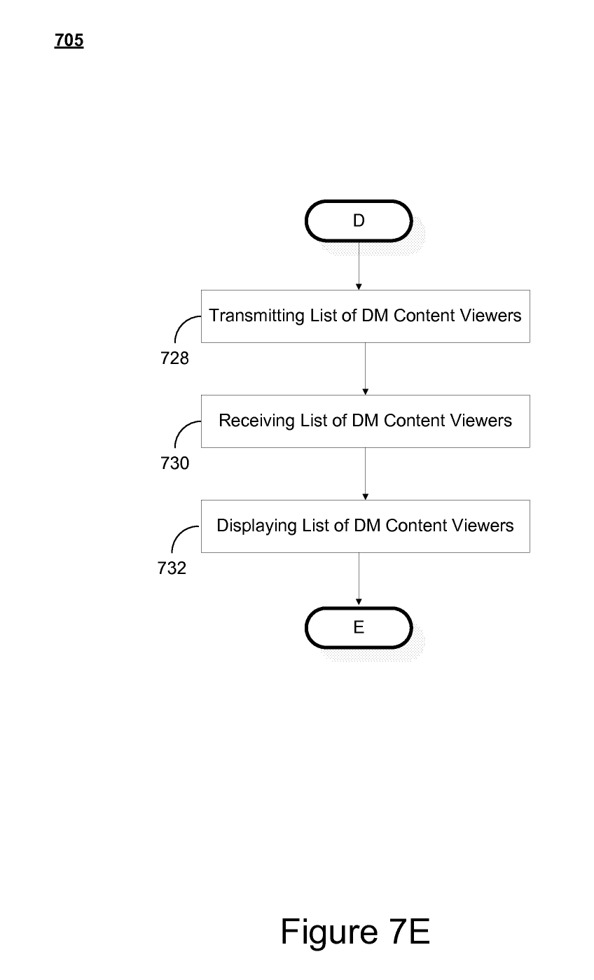

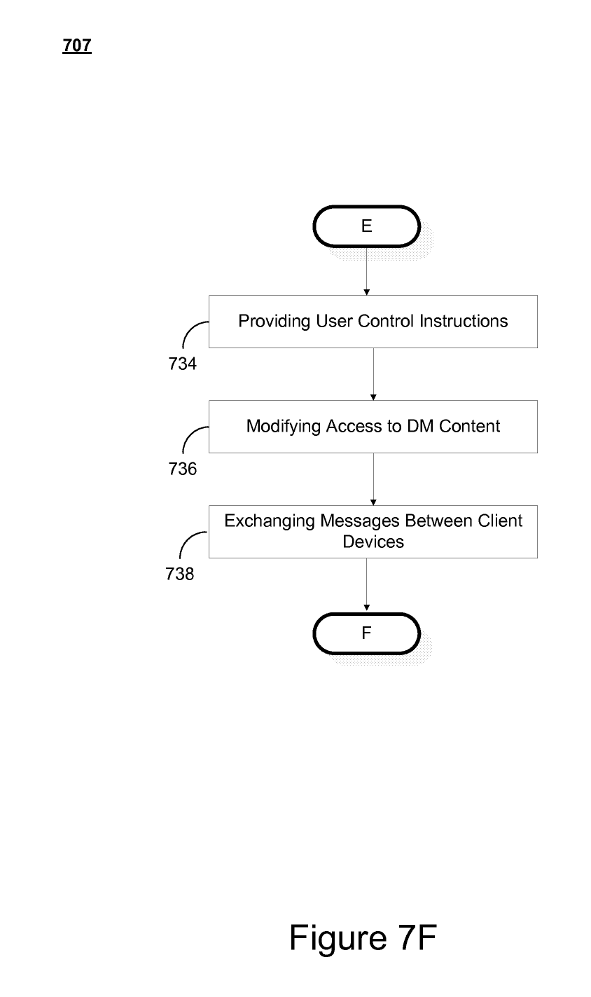

FIGS. 7A-7F are flowcharts that show exemplary methods of accessing and sharing of digital media content among users of client devices with a web server and a remote digital media content server. A step in the method may be providing control instructions by a first control client device using one or more client software applications to the web server across the communication network, the control instructions identifying digital media content located in the remote digital media content server and requesting the web server to provide access to the digital media content, as shown in block 702. Such control instructions may be provided when a first control user views DM content on a user interface using a DM content player. The DM content player may have a control button that allows the first control user to share the DM content with other users. Selection of the control button may provide the control instructions to the web server. A further step may be the web server receiving and processing the control instructions, as shown in block 704. A Web Based Exchange Program (WEP) may be used to process the control instructions. An additional step may be the WEP accessing the digital media content from the remote digital media content server and storing the digital media content in the one or more server storage devices based on the control instructions, as shown in block 706. Another step may be the WEP generating and hosting a web page with a unique web address by the web server, the web page embedded with the digital content and a digital content player, as shown in block 708. A further step may be the WEP providing the web page to the first control client device by the web server, as shown in block 709.

Referring to FIG. 7B, an additional step in the method may be receiving the digital media content embedded as a web page by the first control client device, the web page having a unique web address and display, as shown in block 710. Another step may be sending a notification using a communication method by the first control client device to each client device in the set of invited client devices, the notification including a hyperlink to the unique web address, as shown in block 712. A further step may be receiving the notification having the hyperlink to the unique web address from the first control client device by a client device in the set of invited client devices, as shown in block 714. An additional step may be a client device in the set of invited client device selecting the hyperlink causing invitation instructions to be sent to the web server, the invitation instructions requesting the web server to provide access to, and substantially synchronous play of the digital media content among the first control client device and each client device in the set of invited client devices, as shown in block 715.

Referring to FIG. 7C, another step in the method may be receiving and processing the invitation instructions from each client device in the set of invited client devices by the WEP, as shown in block 716. A further step may be the WEP providing the web page with the embedded DM content to each client device in the set of invited client devices, as shown in block 718. An additional step may be one or more client software applications substantially synchronizing play of the digital media content on the first control client device and each client device in the set of invited client devices based on synchronization instructions provided by the WEP, as shown in block 720.

Referring to FIG. 7D, another step may be in the method may be a first control user sending a designated time instant associated with the digital media content to the web server, as shown in block 722. A further step may be the WEP receiving the designated time instant by the web server, as shown in block 724. An additional step may be one or more client software applications substantially synchronizing play of the digital media content from the designate time instant on the first control client device and each client device in the set of invited client devices by the web server, as shown in block 726. Such a step in the method may implemented by the WEP providing instructions to the first control client device and each client device in the set of invited client devices to buffer sufficient amount of the DM content to synchronously play the DM content on the client device.

Referring to FIG. 7E, another step in the method may be the web server transmitting a list of digital content media content viewers, to the first client device and the set of invited client devices that includes a first digital content viewer corresponding to the first client device and a set of invited digital media content viewers corresponding to the set of invited client devices, as shown in block 728. A further step may be receiving a list of digital media content viewers by the first client device and each client device in the set of invited client devices, as shown in block 730. An additional step may be the first client device and each client device in the set of invited client devices displaying the list of digital media content viewers on the user interface displaying the digital media content, as shown in block 732.

Referring to FIG. 7F, another step in the method may be a control user providing user control instructions that include instructions that designate a set of control client devices that provides additional control instructions to the web server, as shown in block 734. A further step may be the WEP modifying the access, streaming, and control of the digital media content by the web server to the first client device and each client device in the set of invited client devices and the set of control client devices based on the user control instructions, as shown in block 736. An additional step may be exchanging messages between DM content displaying client devices using one or more messaging client software applications, as shown in block 738.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A system for sharing digital media content between a plurality of users across a communication network, the system comprising:
(a) a web server coupled to the communication network using one or more server communication interfaces, the web server having one or more server processors coupled to one or more server storage devices, the one or more server processors executing one or more server software applications;
(b) one or more client devices communicatively coupled to the web server across the communication network using one or more client communication interfaces, each of the one or more client devices having client processors coupled to one or more client storage devices, the one or more client processors executing one or more client software applications wherein a first control client device and a set of invited client devices are a subset of the one or more client devices;
(c) a remote digital media content server coupled to the communication network using one or more server communication interfaces, the remote digital media content server having one or more content server processors coupled to one or more content server storage devices, the one or more content server processors executing one or more content server software applications wherein the digital media content is stored at the remote digital content server in one of the one or more content server storage devices;
(d) wherein the first client device: (i) provides control instructions using one or more client software applications to the web server across the communication network, the control instructions identifying digital media content located in the remote digital media content server and requesting the web server to provide access to the digital media content; (ii) receives the digital media content embedded as a web page, the web page having a unique web address; (iii) sends a notification using a communication method to each client device in the set of invited client devices, the notification including a hyperlink to the unique web address; (iv) receives synchronization instructions to substantially synchronize play the digital media content among the each client device in the set of invited client devices;
(e) wherein each client device in the set of invited client devices (i) receives the notification having the hyperlink to the unique web address from the first control client device; (ii) selects the hyperlink causing invitation instructions to be sent to the web server, the invitation instructions requesting the web server to provide access to, and substantially synchronous play of the digital media content among the first control client device and each client device in the set of invited client devices; (iii) receives synchronization instructions to substantially synchronize play the digital media content among the each client device in the set of invited client devices and the first control client device;
(f) wherein the web server (i) receives and processes the control instructions from the first control client device, and receives and processes the invitation instructions for each client device in the set of invited client devices, across the communication network; (ii) accesses the digital media content from the remote digital media content server and stores the digital media content in the one or more server storage devices based on the control instructions; (iii) generates and hosts a web page with a unique web address, the web page embedded with the digital content and a digital content player; (iv) provides the web page to the first control client device and each client device in the set of invited client devices; (v) provides synchronization instructions to the first control client device and each client device in the set of invited client devices to substantially synchronize play of the digital media content on the first control client device and each client device in the set of invited client devices.

2. The system according to claim 1, wherein the first control client device sends a designated time instant associated with the digital content to the web server and the web server receives the designated time instant and provides synchronization instructions to the first control client device and each client device in the set of invited client devices to substantially synchronize play of the digital media content from the designate time instant on the first control client device and each client device in the set of invited client devices.

3. The system according to claim 1, wherein:
(a) the web server provides to the first control client device and each client device in the set of invited client devices a list of digital media content viewers that includes a first digital content viewer corresponding to the first client device and a set of invited digital media content viewers corresponding to the set of invited client devices; and
(b) the first control client device and each client device in the set of invited client devices receive a list of digital media content viewers and displays the list of digital media content viewers on the user interface displaying the digital media content.

4. The system according to claim 1, wherein the first control client device provides user control instructions that include instructions that designate a set of control client devices that provides additional control instructions to the web server, the web server modifies the access, streaming, and control of the digital media content to the first client device and each client device in the set of invited client devices and the set of control client devices based on the user control instructions.

5. The system according to claim 5, the system further comprising:
(a) a list of contacts associated with the social networking website and a database of contacts wherein the first control client device provides a notification based on the list of contacts associated with the social networking website and the database of contacts. (b) one or more content displaying client devices that display the digital media content wherein each content displaying client device exchange messages with other content displaying client devices using one or more messaging client software applications wherein the one or more messaging software applications can be selected from the group consisting of Instant Messaging, Voice over IP, email, mobile texting, Twitter, Facebook, and Chat software applications;
(c) wherein a subset of the one or more client software applications are one or more client social networking software applications and a subset of the one or more server software applications are server social networking software applications.

6. A method for sharing digital media content between a plurality of users across a communication network, the method comprising:
(a) providing control instructions by a first control client device using one or more client software applications to the web server across the communication network, the control instructions identifying digital media content located on the remote digital media content server and requesting the web server to provide access to the digital media content;
(b) receiving and processing the control instructions from the first control client device by a web server;
(c) accessing the digital media content from the remote digital media content server and storing the digital media content in the one or more server storage devices based on the control instructions;
(d) generating and hosting a web page with a unique web address by the web server, the web page embedded with the digital media content and a digital media content player;
(e) providing the web page to the first control client device by the web server;
(f) receiving the digital media content embedded as a web page by the first control client device, the web page having a unique web address;
(g) sending a notification using a communication method by the first control client device to each client device in the set of invited client devices, the notification including a hyperlink to the unique web address;
(h) receiving the notification having the hyperlink to the unique web address from the first control client device by a client device in the set of invited client devices;
(i) selecting the hyperlink causing invitation instructions to be sent to the web server, the invitation instructions requesting the web server to provide access to, and synchronization instructions to substantially synchronous play of the digital media content among the first control client device and each client device in the set of invited client devices;
(j) receiving and processing the invitation instructions for each client device in the set of invited client devices, across the communication network;
(k) providing the web page to each client device in the set of invited client devices;
(l) substantially synchronizing play of the digital media content on the first control client device and each client device in the set of invited client devices.

7. The method according to claim 7, the method further comprising:
(a) sending a designated time instant associated with the digital content to the web server by the first control client device;
(b) receiving the designated time instant by the web server; and
(c) substantially synchronizing play of the digital media content from the designated time instant on the first control client device and each client device in the set of invited client devices by the web server.

8. The method according to claim 8, the method further comprising:
(a) transmitting a list of digital content media content viewers, by the web server, to the first client device and the set of invited client devices that includes a first digital content viewer corresponding to the first client device and a set of invited digital media content viewers corresponding to the set of invited client devices;
(b) receiving a list of digital media content viewers by first client device and each client device in the set of invited client devices; and
(c) displaying the list of digital media content viewers on the user interface displaying the digital media content.

9. The method according to claim 6, the method further comprising:
(a) providing user control instructions that include instructions that designate a set of control client devices that provides additional control instructions to the web server;
(b) modifying the access, streaming, and control of the digital media content by the web server to the first client device and each client device in the set of invited client devices and the set of control client devices based on the user control instructions.

10. The method according to claim 6, wherein a subset of the one or more client software applications are one or more client social networking software applications and a subset of the one or more server software applications are server social networking software applications

11. The method according to claim 6, further comprising exchanging messages with between digital media content displaying client devices using one or more messaging client software applications.

12. The method according to claim 6, wherein the one or more messaging software applications can be selected from the group consisting of Instant Messaging, Voice over IP, email, mobile texting, Twitter, Facebook , and Chat software applications.

13. A system for sharing digital media content between a plurality of users across a communication network, the system comprising:
(a) one or more client devices;
(a) a web server coupled to the one or more client devices across the communication network, the web server hosting a web page with embedded digital media content and providing the web page embedded with digital media content to one or more client devices and providing synchronization instructions to the one or more client devices to substantially synchronize play of the digital media content among the one or more client devices;
(c) wherein each of the one or more client devices receives the web page having the embedded digital media content and the synchronization instructions, and each client device substantially synchronizes play of the digital media content based on the synchronization instructions.

14. The system according to claim 13, wherein a first control client device sends a designated time instant associated with the digital content to the web server and the web server receives the designated time instant and provides synchronization instructions to the one or more client devices to substantially synchronize play of the digital media content from the designate time instant on the one or more client devices.

15. The system according to claim 13, wherein:
(a) the web server provides to the one or more client devices a list of digital media content viewers that includes a first digital content viewer corresponding to the first client device and a set of invited digital media content viewers corresponding to a set of invited client devices.
(b) the first control client device and each client device in the set of invited client devices receive a list of digital media content viewers and displays the list of digital media content viewers on the user interface displaying the digital media content.

16. The system according to claim 14, wherein the first control client device provides user control instructions that include instructions that designate a set of control client devices that provides additional control instructions to the web server, the web server modifies the access, streaming, and control of the digital media content to the first client device and each client device in the set of invited client devices and the set of control client devices based on the user control instructions.

17. The system according to claim 14, wherein the web server implements one or more server social networking software applications to host the web page with embedded digital media content and provide the web page embedded with digital media content to one or more client devices and synchronization instructions to the one or more client devices and each of the one or more client devices implement one or more client social networking software applications to receive the web page having the embedded digital media content and the synchronization instructions, and to substantially synchronize play of the digital media content among the one or more client devices based on the synchronization instructions.

18. The system according to claim 17, the system further comprising a list of contacts associated with a social networking website and a database of contacts.

19. The system according to claim 13, further comprising one or more content displaying client devices that display the digital media content wherein each content displaying client device exchange messages with other content displaying client devices using one or more messaging client software applications.

20. The system according to claim 19, wherein the one or more messaging software applications can be selected from the group consisting of Instant Messaging, Voice over IP, email, mobile texting, Twitter, Facebook, and Chat software applications.
